(19) United States
(12) Patent Application Publication
(10) Pub. No.: US 2009/0033084 A1
(43) Pub. Date: Feb. 5, 2009

(54) Sensor assembly for a vehicle occupant protection device

(75) Inventors: Wade J. Sorensen, Macomb Township, MI (US); Scott M. Franz, Clawson, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/888,404

(22) Filed: Aug. 1, 2007

(51) Int. Cl. B60R 22/46

(52) U.S. Cl. 280/806

(57) ABSTRACT

A vehicle occupant protection device (30) for helping to protect an occupant of a seat (10) of a vehicle (12) includes an inertia member (134,334) engaging an element (136,330). The inertia member (134,334) is movable relative to the element (136,330) from an unactuated position to an actuated position in response to at least one sensed vehicle condition for activating the occupant protection device (30). One of the inertia member (134,334) and the element (136,330) has a first surface portion (224,426) extending at a first angle (α, A) relative to a vertical axis (222,422) extending through the center of mass of the inertia member (134,334) when the inertia member (134,334) is in the unactuated position. The one of the inertia member (134,334) and the element (136,330) has a second surface portion (228,428) extending at a second angle (θ, B) relative to the axis (222,422) different than the first angle (α, A). The other of the inertia member (134,334) and the element (136,330) is movable along one of the first and second surface portions when the inertia member (134,334) moves into the actuated position.

### FIELD OF THE INVENTION

The present invention relates to a vehicle occupant protection device for helping to protect an occupant of a seat of a vehicle. In particular, the present invention relates to a vehicle sensitive sensor assembly for activating the occupant protection device.

### BACKGROUND OF THE INVENTION

An occupant protection device for helping to protect an occupant of a seat of a vehicle may include a vehicle sensitive sensor assembly. The vehicle sensitive sensor assembly activates the occupant protection device to help protect the occupant of the seat. The vehicle sensitive sensor assembly is responsive to certain vehicle conditions, such as vehicle deceleration and tilt. The vehicle occupant protection device may include a seat belt retractor mounted in a backrest portion of the seat. The vehicle sensitive sensor may prevent rotation of the spool of the retractor in a belt withdrawal direction in response to sensed vehicle conditions.

The vehicle sensitive sensor assembly may include a first inertia member movable relative to a second inertia member to prevent rotation of the spool in the belt withdrawal direction. The second inertia member may have a spherical cavity and be supported for pivotal movement about a gimbal axis extending transverse to the fore-aft direction of the vehicle. Accordingly, the sensitivity of the sensor assembly may be reduced in the fore-aft direction of the vehicle.

### SUMMARY OF THE INVENTION

The present invention relates to a vehicle occupant protection device for helping to protect an occupant of a seat of a vehicle. An inertia member engages an element. The inertia member is movable relative to the element from an unactuated position to an actuated position in response to at least one sensed vehicle condition for activating the occupant protection device. One of the inertia member and the element has a first surface portion extending at a first angle relative to a vertical axis extending through the center of mass of the inertia member when the inertia member is in the unactuated position. The one of the inertia member and the element has a second surface portion extending at a second angle relative to the axis different than the first angle. The other of the inertia member and the element is movable along one of the first and second surface portions when the inertia member moves into the actuated position.

According to another aspect, the present invention relates to a vehicle occupant protection device for helping to protect an occupant of a seat of a vehicle including an inertia member engaging an element. The inertia member is movable relative to the element from an unactuated position to an actuated position in response to at least one sensed vehicle condition for activating the occupant protection device. One of the inertia member and the element has an elliptical cavity. The other of the inertia member and the element extends into the elliptical cavity.

According to yet another aspect, the present invention relates to a vehicle occupant protection device for helping to protect an occupant of a seat of a vehicle including a seat belt retractor for mounting on a backrest portion of the seat. The retractor includes a spool on which seat belt webbing is wound. The spool is supported for rotation about an axis in a belt retraction direction and in an opposite belt withdrawal direction. An inertia locking mechanism blocks rotation of the spool in the belt withdrawal direction in response to at least one sensed vehicle condition. The inertia locking mechanism includes a first inertia member and an element engaging the inertia member. The inertia member is movable relative to the element from an unactuated position to an actuated position in response to the at least one sensed vehicle condition. One of the inertia member and the element has (a) a first surface portion extending at a first angle relative to a vertical axis extending through the center of mass of the first inertia member when the first inertia member is in the unactuated position and (b) a second surface portion extending at a second angle relative to the vertical axis different from the first angle. The other of the inertia member and the element is movable along one of the first and second surface portions when the inertia member moves into the actuated position.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of an occupant protection device constructed in accordance with the present invention for helping to protect an occupant of a seat of a vehicle;

FIG. 2 is a schematic side view of the seat illustrated in FIG. 1;

FIG. 3 is a partially exploded schematic view of a retractor of the occupant protection device of FIGS. 1 and 2 illustrating a first embodiment of a vehicle sensitive sensor assembly;

FIG. 4 is a schematic side view of the retractor of the occupant protection device of FIG. 1 illustrating the retractor in a first position;

FIG. 5 is a schematic side view of the retractor illustrating the retractor in a second position;

FIG. 6 is a schematic sectional view of the vehicle sensitive sensor assembly of the retractor;

FIG. 7 is a plan view of a portion of the vehicle sensitive sensor assembly;

FIG. 8 is a sectional view of the portion of the vehicle sensitive sensor assembly taken along line 8-8 in FIG. 7;

FIG. 9 is a sectional view of the portion of the vehicle sensitive sensor assembly taken along line 9-9 in FIG. 7;

FIG. 10 is a schematic view of portions of a second embodiment of a vehicle sensitive sensor assembly; and

FIG. 11 is a schematic view of the portions of the vehicle sensitive sensor assembly of FIG. 10 taken along the line 11-11 in FIG. 10.

### DETAILED DESCRIPTION OF EXAMPLE EMBODIMENTS

FIG. 1 illustrates a seat 10 of a vehicle 12. The seat 10 includes a cushion portion 14 and a backrest portion 16. The cushion portion 14 of the seat 10 is mountable to the vehicle 12 through rails 18. The rails 18 support the cushion portion 14 of the seat 10 relative to the vehicle 12 and enable forward and rearward movement of the cushion portion relative to the vehicle. The backrest portion 16 of the seat 10 extends upwardly from the cushion portion 14. A headrest portion 20 of the seat 10 is located above the backrest portion 16.

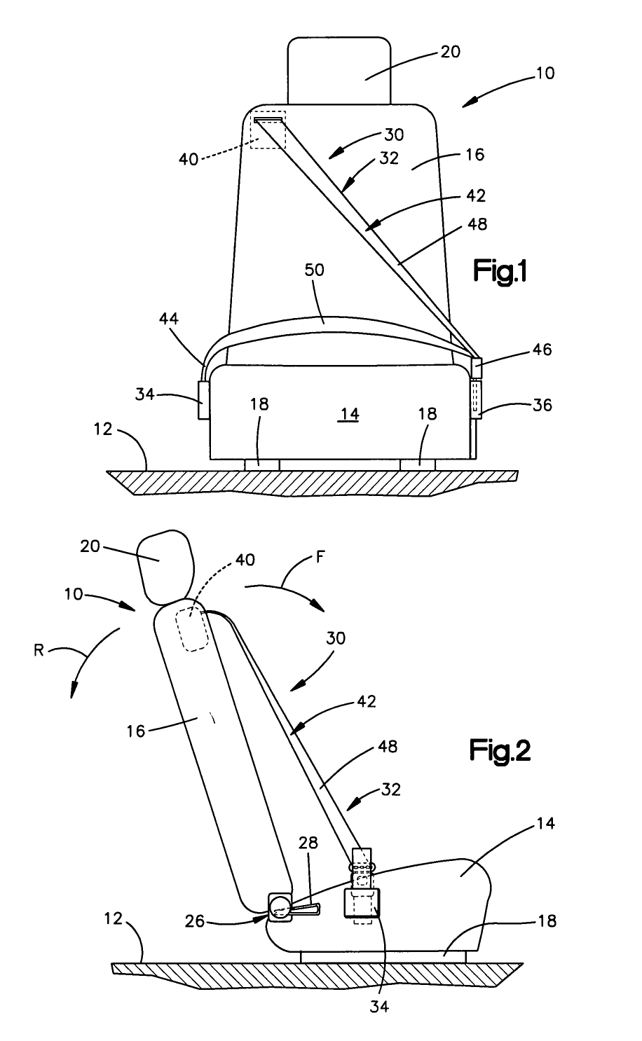

A pivot mechanism (not shown) pivotally attaches the backrest portion 16 of the seat 10 to the cushion portion 14 of the seat. The pivot mechanism enables pivotal movement of the backrest portion 16 of the seat 10 relative to the cushion portion 14 of the seat in both forward and rearward directions. FIG. 2 illustrates the backrest portion 16 in an upright condition. When the backrest portion 16 is pivoted in the forward direction, shown by arrow F in FIG. 2, from the upright condition, the seat 10 is placed in a folded condition. When the backrest portion 16 is pivoted in the rearward direction, shown by arrow R in FIG. 2, from the upright condition, the seat 10 is placed in a reclined condition.

The pivot mechanism includes a latch mechanism 26 that is movable between latched and unlatched conditions. FIG. 2 illustrates a handle 28 of the latch mechanism 26. When the latch mechanism 26 is in the latched condition, the backrest portion 16 of the seat 10 is fixed relative to the cushion portion 14 of the seat. When the latch mechanism 26 is in the unlatched condition, the backrest portion 16 of the seat 10 is pivotable relative to the cushion portion 14 of the seat. To move the latch mechanism 26 between the latched and unlatched conditions, the handle 28 is moved relative to the cushion portion 14 of the seat 10. When the handle 28 is in the position shown in FIG. 2, the latch mechanism 26 is in the latched condition. When the handle 28 is pulled upwardly from the position shown in FIG. 2, the latch mechanism 26 is in the unlatched condition.

FIGS. 1 and 2 also illustrate an occupant protection device 30 for helping to protect an occupant of the seat 10 of the vehicle 12. The occupant protection device 30 may include a seat belt system 32 that is associated with the seat 10 of the vehicle 12. The seat belt system 32 may be a three-point continuous loop seat belt system connected with the seat 10. The seat belt system 30 includes an anchor 34 that is secured to the left side, as viewed in FIG. 1, of the cushion portion 14 of the seat 10. A buckle assembly 36 is secured to the right side, as viewed in FIG. 1, of the cushion portion 14 of the seat 10. The seat belt system 32 also includes a seat belt webbing retractor 40. The retractor 40 is mounted within the backrest portion 16 of the seat 10 at a location adjacent the left side of the seat, as viewed in FIG. 1.

The seat belt system 32 also includes a length of seat belt webbing 42. A first end 44 (FIG. 1) of the seat belt webbing 42 is secured to the anchor 34. A second end (not shown) of the seat belt webbing 42 is fixed to the retractor 40. A tongue assembly 46 is located on the seat belt webbing 42 between the retractor 40 and the anchor 34. The tongue assembly 46 is movable along the seat belt webbing 42.

When the seat belt system 32 is not in use, the seat belt webbing 42 is oriented generally vertically between the retractor 40 and the anchor 34. To engage the seat belt system 32, the tongue assembly 46 is manually grasped and is pulled across the occupant of the seat 10. As the tongue assembly 46 is pulled across the occupant, the tongue assembly 46 moves along the seat belt webbing 42 and seat belt webbing is withdrawn from the retractor 40. The movement of the tongue assembly 46 across the occupant pulls the seat belt webbing 42 across the lap and torso of the occupant. After the seat belt webbing 42 has been pulled across the lap and torso of the occupant, the tongue assembly 46 is inserted into the buckle assembly 36 and is latched in the buckle assembly. When the tongue assembly 46 is latched in the buckle assembly 36, the seat belt webbing 42 is in the position shown in FIG. 1.

When the tongue assembly 46 is latched in the buckle assembly 36, the tongue assembly 46 divides the seat belt webbing 42 into a torso portion 48 and a lap portion 50 (FIG. 1). The torso portion 48 of the seat belt webbing 42 extends between the retractor 40 and the tongue assembly 46 and extends across the torso of the occupant of the seat 10. The lap portion 50 of the seat belt webbing 42 extends between the tongue assembly 46 and the anchor 34 and extends across the lap of the occupant of the seat 10.

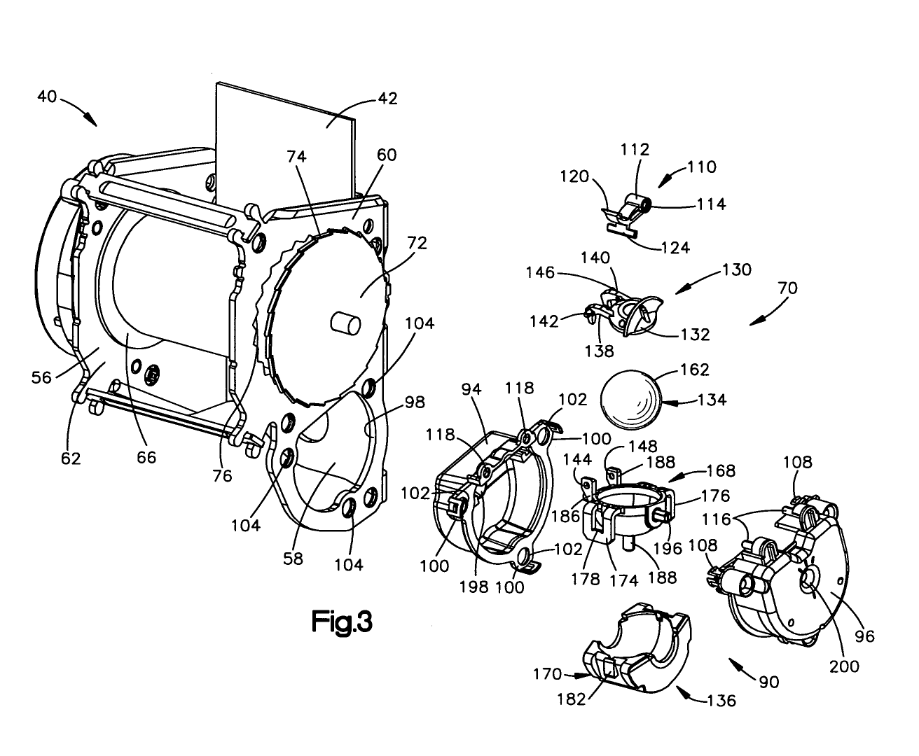

The retractor 40 (FIGS. 3-5) includes a generally U-shaped frame 56. The frame 56 includes a base wall 58 and opposite first and second side walls 60 and 62. The base wall 58 of the frame 56 includes an aperture (not shown) for receiving a fastener (not shown) for fixing the retractor 40 to the backrest portion 16 of the seat 10. The retractor 40 includes a rotatable spool 66 extending between the first and second side walls 60 and 62. The second end of the seat belt webbing 42 is wound on the spool 66 in any desired manner. A rewind spring (not shown) biases the spool 66 in a belt retraction direction.

The retractor 40 also includes an inertia locking mechanism 70. The inertia locking mechanism 70 blocks rotation of the spool 66 in a belt withdrawal direction in response to at least one sensed vehicle condition, such as vehicle deceleration and vehicle tilt. The retractor 40 may include other locking mechanisms (not shown) for blocking rotation of the spool 66 in response to other sensed conditions, such as belt withdrawal. Furthermore, the occupant protection device 30 may include a mechanism (not shown) for disabling the inertia locking mechanism 70 from blocking rotation of the spool 66 under certain circumstances, such as when the backrest portion 16 is in a folded condition or when the latch mechanism 26 is in the unlatched condition.

The locking mechanism 70 includes an actuator disc 72 with ratchet teeth 74. The actuator disc 72 is rotatable relative to the spool 66. The actuator disc 72 may be mounted for rotation relative to the spool 66 in any desired manner. A locking pawl (not shown) carried by the spool 66 or the actuator disc 72 may move into engagement with one of a plurality of ratchet teeth 76 on the side wall 60 in response to relative rotation between the spool 66 and the actuator disc 72 to block rotation of the spool in a belt withdrawal direction.

A vehicle sensitive sensor assembly 90 (FIGS. 3-6) for sensing vehicle conditions, such as vehicle deceleration and vehicle tilt, includes first and second cup-shaped cover members 94 and 96. The cover members 94 and 96 are connected to the side wall 60 and support the other components of the vehicle sensitive sensor assembly 90. The first or inner cup-shaped member 94 (FIG. 3) extends into an opening 98 in the side wall 60. The inner member 94 has tabs 100 with openings 102 that are aligned with openings 104 in the side wall 60. The second or outer cup-shaped member 96 includes pins 108 that extend through the openings 102 in the inner member 94 and into the openings 104 in the side wall 60. The pins 108 snap into the openings 104 in the side wall 60 to connect the vehicle sensitive sensor assembly 90 to the side wall 60. The outer member 96 may include hooks that snap into openings in the inner cover member 94 to connect the cover members to each other.

A lock lever or pilot pawl 110 (FIGS. 3-6) is pivotally connected to the cover members 94 and 96. The pilot pawl 110 has a first end portion 112 with an opening 114. One of two pins 116 on the outer cover member 96 extends into the opening 114 to connect the pilot pawl 110 pivotally to the cover members 94 and 96. Accordingly, the pilot pawl 110 may pivot about an axis extending generally parallel to a rotational axis of the spool 66. The pins 116 (FIG. 3) extend from the outer cover member 96 into openings 118 in the inner cover member 94. The pilot pawl 110 may be mounted on either pin 116 depending on the orientation of the retractor 40 in the vehicle 12.

A second end portion 120 of the pilot pawl 110 projects away from the pin 116. An upper surface of the second end portion 120 projects upward in a direction toward the ratchet teeth 74 on the actuator disc 72. A lower surface of the second end portion 120 of the pilot pawl 110 is formed as a downwardly projecting rib 124. The rib 124 engages a sensor lever element 130.

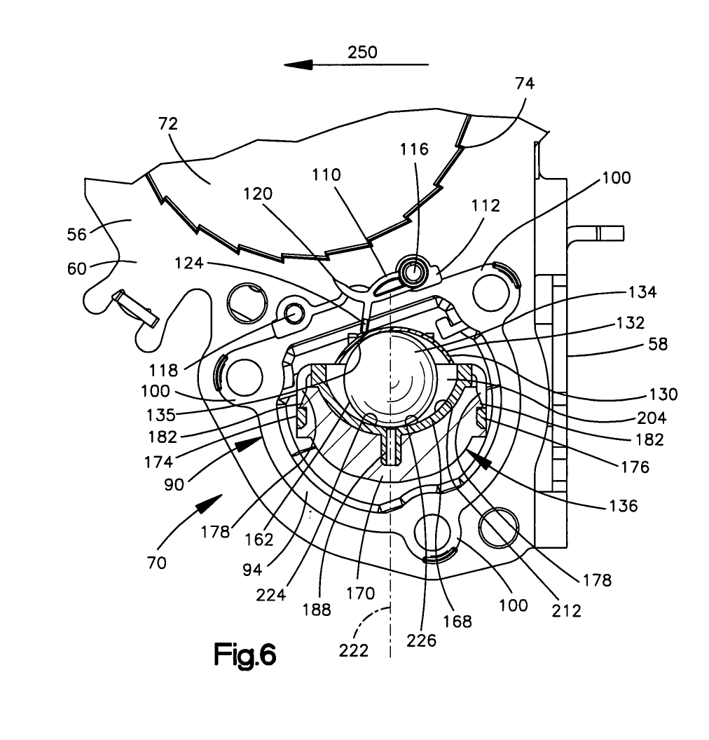

A cap portion 132 (FIGS. 3 and 6) of the sensor lever element 130 is disposed above and rests upon a first inertia member 134. The cap portion 132 has a lower surface 135 engaging the first inertia member 134. The cap portion 132 of the sensor lever 130 engages the underside of the downwardly projecting rib 124 on the pilot pawl 110.

The sensor lever element 130 is pivotally connected to a second inertia member or support element 136. The sensor lever element 130 (FIG. 3) has two parallel lever arms 138 and 140. A pivot pin 142 on the sensor lever arm 138 is received in an opening 144 in the support element 136. A pivot pin 146 on the sensor lever arm 140 is received in an opening 148 on the support element 136. The sensor lever element 130 is thus supported on the support 136 by the lever arms 138 and 140 for pivotal movement about a sensor lever axis relative to the support element 136. The sensor lever axis extends transverse to the pivot axis of the pilot pawl 110 and the axis of the spool 66. Upon pivotal movement of the sensor lever element 130 relative to the support element 136, the pilot pawl 110 pivots relative to the cover members 94 and 96.

The first inertia member 134 may be a ball formed from a corrosion resistant metal or other high density material. The first inertia member 134 has a spherical outer surface 162 that engages the second inertia member or support element 136. The outer surface 162 of the first inertia member 134 also engages the lower surface 135 of the cap portion 132 of the sensor lever element 130. The second inertia member 136 supports the first inertia member 134 for movement between an unactuated position and actuated positions in which the inertia locking mechanism 70 blocks rotation of the spool 66 in the belt withdrawal direction.

The second inertia member or support element 136 (FIGS. 3 and 7-9) includes a shell 168 connected to a weight member 170. The shell 168 made be made of an elastomer and the weight member 170 may be formed from a corrosion resistant metal or other high density material. The shell 168 includes arms 174 and 176 extending downwardly from opposite sides of the shell 168. Hooks 182, one of which is shown in FIG. 3, on the weight member 170 extend into openings 178 on the arms 174 and 176. The arms 174 and 176 snap over the hooks 182 to connect the weight member 170 to the shell 168. The shell 168 also includes a downwardly extending pin 188 that extends into an opening in the weight member 170 to connect the shell to the weight member. The shell 168 and the weight member 170 may, however, be connected in any desired manner.

The shell 168 includes upwardly extending arms 186 and 188 for pivotally supporting the sensor lever element 130. The arms 186 and 188 include the openings 144 and 148. The openings 144 and 148 receive the pivot pins 142 and 146 of the sensor lever element 130 to support the sensor lever pivotally.

The shell 168 (FIGS. 3 and 7-9) includes pivot posts 194 and 196 extending generally parallel to the axis of the spool 66 from opposite sides of the shell. The pivot post 194 extends into an opening 198 in the inner cover member 94. The pivot post 196 extends into an opening 200 in the outer cover member 96. Accordingly, the second inertia member 136 is supported for pivotal movement about a gimbal axis relative to the inner and outer cover members 94 and 96 and the frame 56 of the retractor 40. The gimbal axis extends generally parallel to the axis of the spool 66.

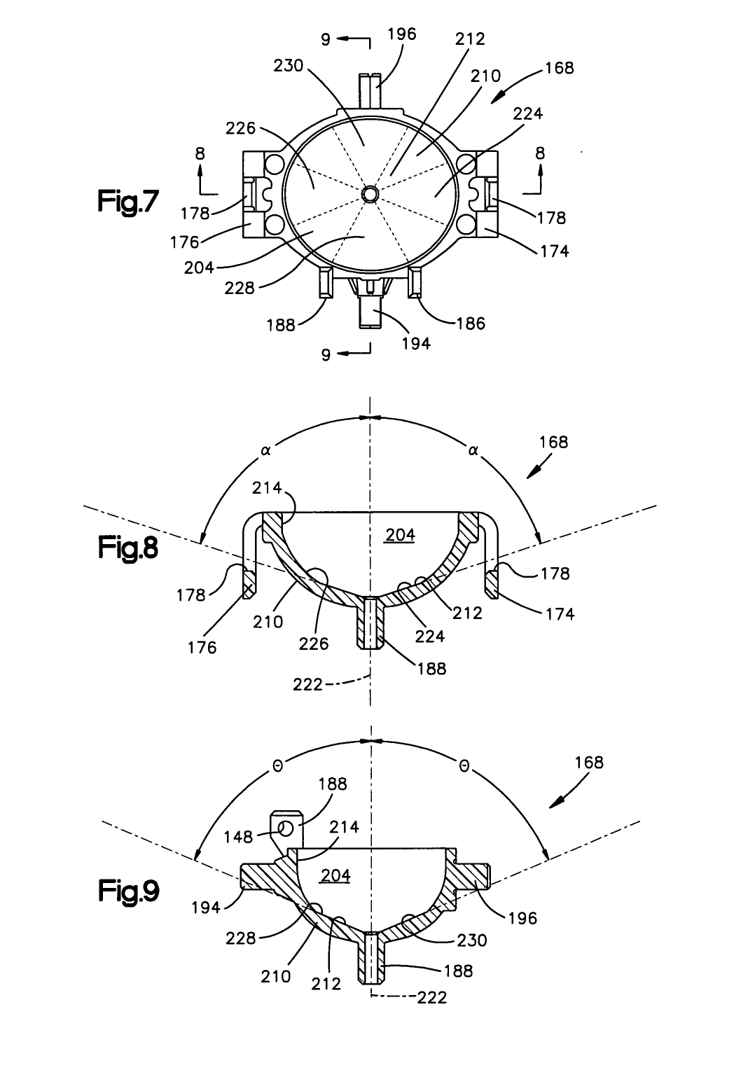

The shell 168 (FIGS. 7-9) has a generally elliptical cavity 204. A bottom wall portion 210 of the shell 168 has a generally frustoconical upwardly facing ramp surface 212. The ramp surface 212 extends upwardly to a cylindrical wall portion 214. The ramp surface 212 and the cylindrical wall portion 214 of the shell 168 partially define the cavity 204 in the shell. The first inertia member 134 (FIG. 6) is disposed on the ramp surface 212 and in the cavity 204. The center of mass of the first inertia member 134 is disposed above the ramp surface 212. The center of mass of the second inertia member 136, that is, of the combined shell 168 and weight member 170, is disposed below the gimbal axis and below the ramp surface 212.

The ramp surface 212 (FIGS. 7-9) includes first and second surface portions 224 and 226. The first and second surface portions 224 and 226 extend upwardly from a bottom of the ramp surface 212 and in a generally fore-aft direction of the vehicle 12. Each of the surface portions 224 and 226 (FIG. 8) also extends at a first angle α relative to a vertical axis 222 extending through the center of mass of the first inertia member 134 when the first inertia member is in the unactuated position. Although the first and second surface portions 224 and 226 are shown as extending at the same angle relative to the axis 222, the first and second surface portions may extend at different angles relative to the axis 222.

The ramp surface 212 includes third and fourth surface portions 228 and 230 extending upwardly from the bottom of the ramp surface 212 and generally transverse to the fore-aft direction of the vehicle 12. Each of the third and fourth surface portions 228 and 230 extends at a second angle θ to the vertical axis 222. The second angle θ is less than the first angle α. Although the third and fourth surface portions 228 and 230 are shown as extending at the same angle relative to the axis 222, the third and fourth surface portions may extend at different angles relative to the axis 222. The first angle α may be between 70° and 80° and the second angle θ may be approximately 1°-4° less than the first angle. The first angle α may be approximately 77° and the second angle θ may be approximately 75°.

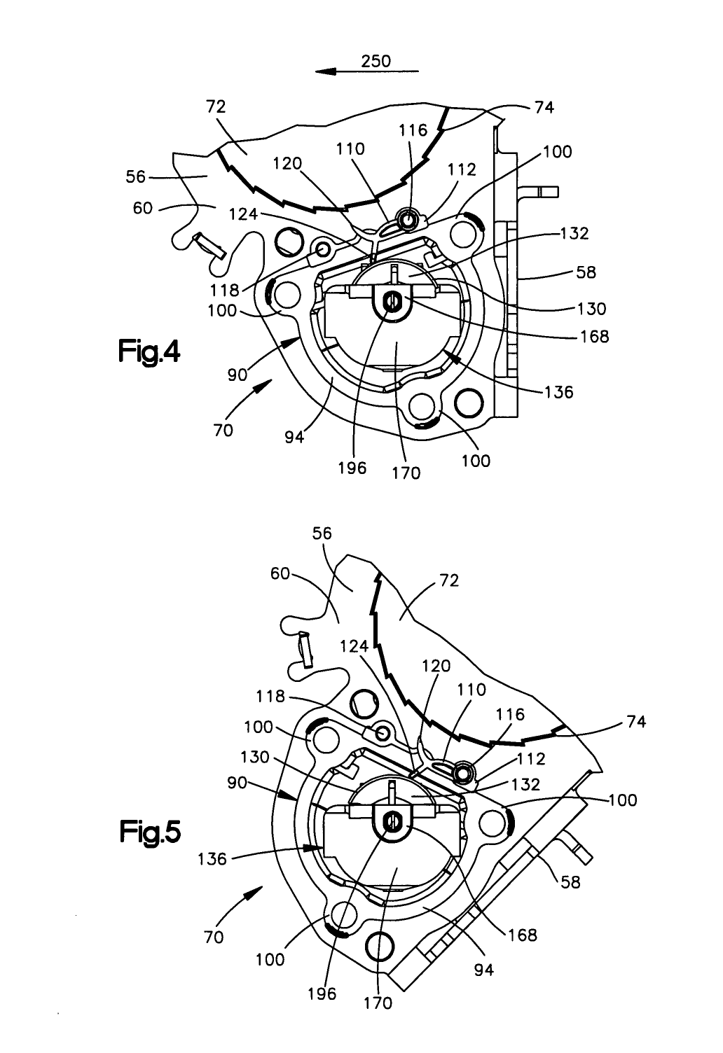

The vehicle seat backrest portion 16 (FIG. 1) can be reclined relative to the seat cushion portion 14 to place the retractor 40 in a plurality of different inclined orientations. FIG. 4 shows the retractor 40 in a first inclined orientation and FIG. 5 shows the retractor in a second inclined orientation. The parts of the retractor 40 are illustrated in FIGS. 4 and 5 in a condition with the vehicle 12 moving at a steady speed in a forward direction as indicated by the arrow 250. The first inertia member 134 and the second inertia member or support element 136 are in a predetermined orientation relative to the other parts of the retractor 40. In this predetermined orientation, the center of mass of the first inertia member 134 is disposed vertically above the center of mass of the second inertia member 136. The first inertia member 134 is centered on the ramp surface 212. The pilot pawl 110 is spaced from the ratchet teeth 74 on the actuator disc 72.

In the event of sudden vehicle deceleration, the parts of the retractor 40 that are supported for pivotal movement about the gimbal axis continue to move forward relative to the other parts of the retractor, which decelerate. The parts that continue to move forward include the first and second inertia members 134 and 136. Because the center of mass of the second inertia member 136 is disposed below the gimbal axis, the second inertia member swings forward and upward, pivoting about the gimbal axis, in a clockwise direction as viewed in FIG. 4. At the same time, the first inertia member 134 rolls forward and upward along the first surface portion 224 of the shell 168 of the second inertia member or support element 136 into an actuated position. The first inertia member 134 also moves relative to the sensor lever element 130.

The first inertia member 134 exerts an upwardly directed force on the sensor lever element 130. The sensor lever element 130 pivots upward about the sensor lever axis. The sensor lever 130 exerts an upwardly directed force on the rib 124 of the pilot pawl 110. The pilot pawl 110 pivots upward about the pilot pawl axis. The pilot pawl 110 moves into the path of revolution of the ratchet teeth 74 on the actuator disc 72 if the deceleration is above a predetermined value.

Should the occupant of the seat 10 move forward relative to the backrest portion 16 as a result of the sudden vehicle deceleration, the occupant engages the belt webbing 42. Forward movement of the occupant then results in withdrawal of belt webbing from the retractor 40. The retractor spool 66 rotates in the belt withdrawal direction. The actuator disc 72 is fixed for rotation with the spool 66 and also rotates in the belt withdrawal direction.

The pilot pawl 110, which is disposed in the path of revolution of the ratchet teeth 74, is engaged by one of the moving ratchet teeth. The pilot pawl 110 prevents further rotation of the actuator disc 72 in the belt withdrawal direction. The spool 66 rotates relative to the actuator disc 72 in the belt withdrawal direction. The relative rotation between the spool 66 and the actuator disc 72 causes the locking pawl (not shown) to pivot into engagement with the ratchet teeth 76 on the side wall 60 to prevent further rotation of the spool 66 in the belt withdrawal direction. It is contemplated, however, that rotation of the spool 66 in the belt withdrawal direction may be prevented in any desired manner in response to movement of the first inertia member 134 from the unactuated position to the actuated positions.

In the event of sudden vehicle acceleration in a direction extending transverse to the fore-aft direction of the vehicle 12, such as during a side impact, the first inertia member 134 rolls upward along one of the third and fourth surface portions 228 and 230 of the shell 168 of the second inertia member 136 into an actuated position. The first inertia member 134 also moves relative to the sensor lever element 130. The first inertia member 134 exerts an upwardly directed force on the sensor lever element 130. The sensor lever element 130 pivots upward about the sensor lever axis. The sensor lever 130 exerts an upwardly directed force on the rib 124 of the pilot pawl 110. The pilot pawl 110 pivots upward about the pilot pawl axis. The pilot pawl 110 moves into the path of revolution of the ratchet teeth 74 on the actuator disc 72 if the sudden vehicle acceleration is above a predetermined value.

Should the occupant of the seat 10 move forward relative to the backrest portion 16 as a result of the sudden vehicle acceleration, the occupant engages the belt webbing 42. Forward movement of the occupant then results in withdrawal of belt webbing from the retractor 40. The retractor spool 66 rotates in the belt withdrawal direction. The actuator disc 72 is fixed for rotation with the spool 66 and also rotates in the belt withdrawal direction.

The pilot pawl 110, which is disposed in the path of revolution of the ratchet teeth 74, is engaged by one of the moving ratchet teeth. The pilot pawl 110 prevents further rotation of the actuator disc 72 in the belt withdrawal direction. The spool 66 rotates relative to the actuator disc 72 in the belt withdrawal direction. The relative rotation between the spool 66 and the actuator disc 72 causes the locking pawl (not shown) to pivot into engagement with the ratchet teeth 76 on the side wall 60 to prevent further rotation of the spool 66 in the belt withdrawal direction. It is contemplated, however, that rotation of the spool 66 in the belt withdrawal direction may be prevented in any desired manner in response to movement of the first inertia member 134 from the unactuated position to the actuated position.

When the backrest portion 16 pivots relative to the cushion portion 14, the retractor frame 56 also tilts. The second inertia member 136, which is supported on the cover members 94 and 96 for pivotal movement about the gimbal axis, maintains its predetermined orientation as shown in FIGS. 4 and 5. The sensor lever element 130 is supported on the second inertia member or support element 136 for movement with the second inertia member about the gimbal axis. Thus, the sensor lever element 130 maintains the same predetermined orientation as the second inertia member 136.

Also, the first inertia member 134 does not move relative to the second inertia member 136 as a result of tilting movement of the backrest portion 16. The first inertia member 134 remains in the centered (unactuated) position shown in FIG. 6. Thus, the first inertia member 160 does not move the sensor lever 130, and the sensor lever does not move the pilot pawl 110 as a result of tilting of the backrest portion 16.

When the backrest portion 16 is pivoted forward or rearward relative to the cushion portion 14 to the second inclined orientation illustrated in FIG. 5, the operation of the vehicle sensitive sensor assembly 90 is generally the same as described above with reference to FIG. 4. This similarity results because the first inertia member 134 and the second inertia member 136 are together supported for pivotal movement about the gimbal axis, which extends parallel to the pivot axis of the backrest portion 16. As a result, the inertia members 134 and 136 remain in their predetermined orientation, identical to that shown in FIG. 6, in which the center of mass of the first inertia member 134 is vertically above the center of mass of the second inertia member 136. Therefore, in the event of sudden vehicle deceleration, the inertia members 134 and 136, the sensor lever 130, the pilot pawl 110, and the actuator disc 72 cooperate to initiate lockup of the retractor spool 66, in the manner described above. This blocks rotation of the spool 66 in the belt withdrawal direction, thus restraining the vehicle occupant.

When the retractor 40 in this manner assumes such a different inclined orientation, the inertia members 134 and 136, as well as the sensor lever element 130 and the pilot pawl 110, assume a different position relative to the other parts of the retractor 40 that are not supported for swinging movement about the gimbal axis. The first inertia member 134, however, remains in the center of the second inertia member 136. Further, the configuration of the outer surface of the sensor lever member 130 maintains the pilot pawl 110 the same distance out of the path of revolution of the ratchet teeth 74 of the actuator disc 72. As a result, the vehicle sensitive sensor assembly 90 does not lock up more quickly when the backrest portion 16 is tilted.

Under normal vehicle conditions, the first inertia member 134 rests on the second inertia member 136 and gravity acts on the sensor lever element 130 to position the cap portion 132 of the sensor lever element upon the first inertia member, as shown in FIGS. 4 and 5. When the cap portion 132 is positioned upon the first inertia member 134, the pilot pawl 110 is spaced away from the ratchet teeth 74 on the actuator disc 72, as is shown in FIGS. 4 and 5. When the first inertia member 134 moves relative to the second inertia member or support element 136 by at least a predetermined amount, as, for example, when the vehicle 12 experiences a sudden deceleration, the pilot pawl 110 moves into engagement with a ratchet tooth 74 of the actuator disc 72. The engagement between the pilot pawl 110 and the ratchet tooth 74 prevents rotation of the actuator disc 72 in the belt withdrawal direction.

When the actuator disc 72 is prevented from rotating in the belt withdrawal direction, the wind up spring resists rotation of the spool 66 in the belt withdrawal direction. When tension on the seat belt webbing 42 overcomes the bias of the wind up spring, as when vehicle deceleration causes a vehicle occupant to apply a load on the seat belt webbing, the spool 66 rotates in the belt withdrawal direction. Since the actuator disc 72 is prevented from rotating in the belt withdrawal direction, the spool 66 rotates relative to the actuator disc 72 and the wind up spring is tensioned. As set forth above, the relative rotation between the actuator disc 72 and the spool 66 pivots the locking pawl (not shown) into the actuated condition in which the locking pawl engages a ratchet tooth 76 on the first side wall 60 of the frame 56. When the locking pawl engages a ratchet tooth 76 on the first side wall 60 of the frame 56, the spool 66 is prevented from rotating in the belt withdrawal direction.

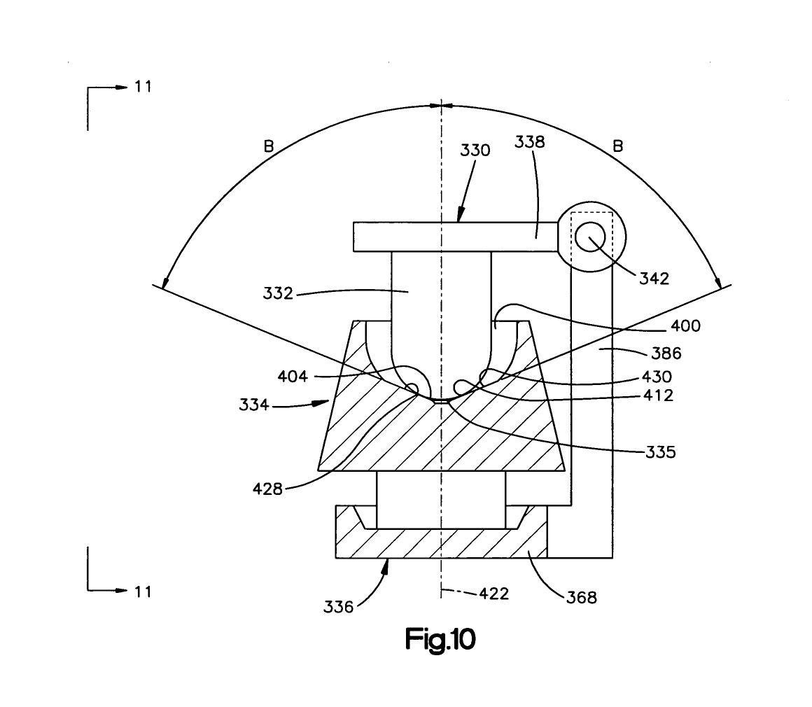

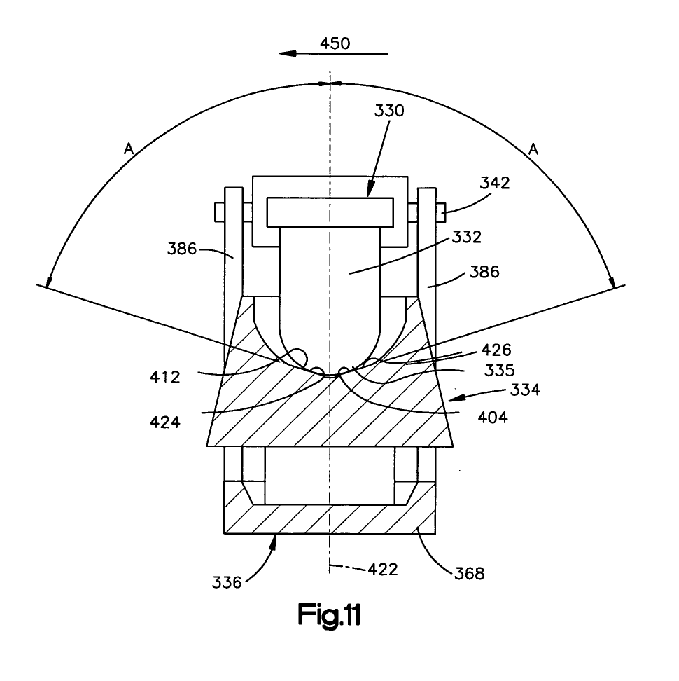

An alternative embodiment of the vehicle sensitive sensor assembly is illustrated in FIGS. 10-11. A sensor lever element 330 (FIGS. 10-11) is disposed above and rests upon a first inertia member 334. The first inertia member 334 may be a “standing man” or a pendulum. A downwardly projecting portion 332 of the sensor lever element 330 has a lower spherically shaped surface 335 engaging the first inertia member 134. The sensor lever element 330 may engage the underside of the downwardly projecting rib 124 on the pilot pawl 110.

The first inertia member 334 has a generally elliptical cavity 404 similar to the cavity 204 of the shell 168. A generally frustoconical upwardly facing ramp surface 412 of the first inertia member 334 defines the cavity 404. The downwardly projecting portion 332 of the sensor lever element 330 is disposed on the ramp surface 412 and in the cavity 404.

The ramp surface 412 (FIG. 11) includes first and second surface portions 424 and 426. The first and second surface portions 424 and 426 extend upwardly from a bottom of the ramp surface 412 and in a generally fore-aft direction of the vehicle 12. Each of the surface portions 424 and 426 also extends at a first angle A relative to a vertical axis 422 extending through the center of mass of the first inertia member 334 when the first inertia member is in the unactuated position, as shown in FIGS. 10 and 11. Although the first and second surface portions 424 and 426 are shown as extending at the same angle relative to the axis 422, the first and second surface portions may extend at different angles relative to the axis 422.

The ramp surface 412 includes third and fourth surface portions 428 and 430 extending upwardly from the bottom of the ramp surface 412 and generally transverse to the fore-aft direction of the vehicle. Each of the third and fourth surface portions 428 and 430 extends at a second angle B to the vertical axis 422. The second angle B is less than the first angle A. Although the third and fourth surface portions 428 and 430 are shown as extending at the same angle relative to the axis 422, the third and fourth surface portions may extend at different angles relative to the axis 422. It is contemplated that the first angle A may be between 70° and 80° and the second angle B may be approximately 1°-4° less than the first angle. The first angle A may be approximately 77° and the second angle B may be approximately 75°.

The sensor lever element 330 is pivotally connected to a second inertia member or support element 336. The sensor lever element 330 has a first end portion 338 pivotally connected to the second inertia member 336. A pivot pin 342 pivotally connects the sensor lever element 330 to the second inertia member 336. The sensor lever element 330 is thus supported on the support 336 for pivotal movement about a sensor lever axis relative to the support 336. Upon pivotal movement of the sensor lever element 330 relative to the support element 336, the pilot pawl 110 pivots.

The second inertia member or support element 336 supports the first inertia member 334 for movement between an unactuated position and actuated positions in which the inertia locking mechanism 70 blocks rotation of the spool 66 in the belt withdrawal direction. The second inertia member or support element 336 may include a shell 368 connected to a weight member (not shown). The shell 368 includes upwardly extending arms 386 for pivotally supporting the sensor lever element 330. The shell 368 may include pivot posts (not shown) supporting the second inertia member 336 for pivotal movement about a gimbal axis. The center of mass of the second inertia member 336, that is, of the combined shell 368 and weight member, is disposed below the gimbal axis.

The parts of the retractor are illustrated in FIGS. 10 and 11 in a condition with the vehicle moving at a steady speed in a forward direction indicated by arrow 450. The first inertia member 334 and the second inertia member 336 are in a predetermined orientation relative to the other parts of the retractor. In this predetermined orientation, the center of mass of the first inertia member 334 is disposed vertically above the center of mass of the second inertia member 336. The first inertia member 334 is centered on the second inertia member 336. The downwardly extending portion 332 of the sensor lever member 330 is also centered in the cavity 404 of the first inertia member 334. Accordingly, the pilot pawl 110 is spaced from the ratchet teeth 74 on the actuator disc 72.

In the event of sudden vehicle deceleration, the parts of the retractor that are supported for pivotal movement about the gimbal axis continue to move forward relative to the other parts of the retractor, which decelerate. The parts that continue to move forward include the first and second inertia members 334 and 336. Because the center of mass of the second inertia member 336 is disposed below the gimbal axis, the second inertia member swings forward and upward, pivoting about the gimbal axis. At the same time, the first inertia member 334 tips forward relative to the second inertia member 336 into an actuated position. The second surface portion 426 moves along the downwardly extending portion 332 of the sensor lever element 330.

The first inertia member 334 exerts an upwardly directed force on the sensor lever element 330. The sensor lever element 330 pivots upward about the sensor lever axis. The sensor lever 330 exerts an upwardly directed force on the rib 124 of the pilot pawl 110. The pilot pawl 110 pivots upward about the pilot pawl axis. The pilot pawl 110 moves into the path of revolution of the ratchet teeth 74 on the actuator disc 72 if the deceleration is above a predetermined value. The rotation of the spool 66 in the belt withdrawal direction is prevented as discussed above.

In the event of sudden vehicle acceleration in a direction extending transverse to the fore-aft direction of the vehicle, such as during a side impact, the first inertia member 334 tips relative to the second inertia member 336 and one of the third and fourth surface portions 428 and 430 moves along the downwardly extending portion 332 of the sensor lever element 330. The first inertia member 334 exerts an upwardly directed force on the sensor lever element 330. The sensor lever element 330 pivots upward about the sensor lever axis. The sensor lever 330 exerts an upwardly directed force on the pilot pawl 110. The pilot pawl 110 pivots upward about the pilot pawl axis. The pilot pawl 110 moves into the path of revolution of the ratchet teeth 74 on the actuator disc 72 if the sudden vehicle acceleration is above a predetermined value and rotation of the spool 66 in the belt withdrawal direction is prevented.

Although the first inertia member 334 is illustrated with a ramp surface 412, it is contemplated that the first inertia member may include a projecting portion engaging a ramp surface on the sensor lever element 330.

The vehicle sensor assemblies may be used to activate any desired vehicle occupant protection device, such as an inflatable vehicle occupant protection device.

From the above description of the invention, those skilled in the art will perceive improvements, changes and modifications in the invention. Such improvements, changes and modifications within the skill of the art are intended to be covered by the appended claims.

Having described the invention, we claim:

1. A vehicle occupant protection device for helping to protect an occupant of a seat of a vehicle, comprising:
an inertia member engaging an element, said inertia member being movable relative to said element from an unactuated position to an actuated position in response to at least one sensed vehicle condition for activating the occupant protection device, one of said inertia member and said element having a first surface portion extending at a first angle relative to a vertical axis extending through the center of mass of said inertia member when said inertia member is in the unactuated position, said one of said inertia member and said element having a second surface portion extending at a second angle relative to the axis different than the first angle, another of said inertia member and said element being movable along one of said first and second surface portions when said inertia member moves into said actuated position.

2. A vehicle occupant protection device as set forth in claim 1 wherein said element includes said first and second surface portions, said element supporting said inertia member for movement relative to said first and second surface portions.

3. A vehicle occupant protection device as set forth in claim 2 wherein said element is supported on a backrest of the seat for pivotal movement relative to the vehicle to maintain a predetermined orientation of said inertia member and of said element when said inertia member is in the unactuated position.

4. A vehicle occupant protection device as set forth in claim 3 wherein said element is pivotally connected with a backrest portion of a vehicle seat, said backrest portion being pivotally connected with a cushion portion of the vehicle seat.

5. A vehicle occupant protection device as set forth in claim 1 wherein said first surface portion extends in a fore-aft direction of the vehicle and said second surface portion extends in a direction extending transverse to the fore-aft direction.

6. A vehicle occupant protection device as set forth in claim 5 wherein said first angle is greater than said second angle.

7. A vehicle occupant protection device as set forth in claim 1 wherein said element has an elliptical cavity.

8. A vehicle occupant protection device as set forth in claim 1 further including a seat belt retractor associated with a seat of the vehicle, said retractor including:
a spool about which seat belt webbing is wound, said spool being supported for rotation in a belt withdrawal direction and in an opposite belt retraction direction;
said inertia member preventing rotation of said spool in the belt withdrawal direction in response to said at least one sensed vehicle condition.

9. The vehicle occupant protection device as set forth in claim 8 wherein a pilot pawl is movable into a position for preventing rotation of said spool in the belt withdrawal direction in response to movement of said inertia member relative to said element.

10. The vehicle occupant protection device as set forth in claim 9 wherein said retractor includes an actuator disc having ratchet teeth, said pilot pawl engaging a ratchet tooth of said actuator disc to prevent rotation of said actuator disc and thereby, prevent rotation of said spool in the belt withdrawal direction.

11. The vehicle occupant protection device as set forth in claim 8 wherein the associated seat includes a backrest portion pivotable relative to a cushion portion, said retractor being movable with said backrest portion relative to said cushion portion.

12. A vehicle occupant protection device for helping to protect an occupant of a seat of a vehicle, comprising:
an inertia member engaging an element, said inertia member being movable relative to said element from an unactuated position to an actuated position in response to at least one sensed vehicle condition for activating the occupant protection device, one of said inertia member and said element having an elliptical cavity, another of said inertia member and said element extending into said elliptical cavity.

13. A vehicle occupant protection device as set forth in claim 12 wherein said one of said inertia member and said element has a first surface portion extending at a first angle relative to a vertical axis extending through the center of mass of said inertia member when said inertia member is in the unactuated position, said one of said inertia member and said element having a second surface portion extending at a second angle relative to the axis different than the first angle, said other of said inertia member and said element being movable along one of said first and second surface portions when said inertia member moves into one of the actuated positions.

14. A vehicle occupant protection device as set forth in claim 13 wherein said element includes said first and second surface portions, said element supporting said inertia member for movement relative to said first and second surface portions.

15. A vehicle occupant protection device as set forth in claim 13 wherein said element is supported on a backrest portion of the seat for pivotal movement relative to the vehicle to maintain a predetermined orientation of said inertia member and of said element when said inertia member is in the unactuated position.

16. A vehicle occupant protection device as set forth in claim 13 wherein said first surface portion extends in a fore-aft direction of the vehicle and said second surface portion extends in a direction extending transverse to the fore-aft direction, said first angle being greater than said second angle.

17. A vehicle occupant protection device for helping to protect an occupant of a seat of a vehicle comprising:
a seat belt webbing retractor for mounting on a backrest portion of the seat, said retractor including a spool on which seat belt webbing is wound, said spool being supported for rotation about an axis in a belt retraction direction and in an opposite belt withdrawal direction; and
an inertia locking mechanism for blocking rotation of said spool in the belt withdrawal direction in response to at least one sensed vehicle condition, said inertia locking mechanism including a first inertia member and an element engaging said inertia member, said inertia member being movable relative to said element from an unactuated position to an actuated position in response to the at least one sensed vehicle condition, one of said inertia member and said element having a first surface portion extending at a first angle relative to a vertical axis extending through the center of mass of said first inertia member when said first inertia member is in the unactuated position and a second surface portion extending at a second angle relative to the vertical axis different from the first angle, another of said inertia member and said element being movable along one of said first and second surface portions when said inertia member moves into the actuated position.

18. A vehicle occupant protection device as set forth in claim 17 wherein said element and said first inertia member have the same predetermined orientation when the backrest portion is tilted by any amount less than a predetermined amount.

19. A vehicle occupant protection device as set forth in claim 18 wherein said element includes a second inertia member which is supported on the backrest portion for pivotal movement relative to the backrest portion to maintain said predetermined orientation of said first inertia member and of said element when the backrest portion is tilted.

20. A vehicle occupant protection device as set forth in claim 18 wherein said inertia locking mechanism further comprises an actuator disc and a pilot pawl supported for pivotal movement between a disengaged position and an engaged position in engagement with said actuator disc;
said pilot pawl moving from the disengaged position to the engaged position in response to movement of said first inertia member relative to said element from the unactuated position to the actuated position.

21. A vehicle occupant protection device as set forth in claim 20 wherein a sensor lever element has a first surface in engagement with said first inertia member and a second surface in engagement with said pilot pawl.

22. A vehicle occupant protection device as set forth in claim 17 wherein said element is supported for pivotal movement relative to the backrest portion about an axis extending parallel to the axis of tilting of the backrest portion.
